(19) United States
(12) Patent Application Publication
(10) Pub. No.: US 2021/0383214 A1
(43) Pub. Date: Dec. 9, 2021

(54) METHOD FOR LEARNING OF DEEP LEARNING MODEL AND COMPUTING DEVICE FOR EXECUTING THE METHOD

(71) Applicant: SAMSUNG SDS CO., LTD., Seoul (KR)

(72) Inventors: Sun Jin KIM, Seoul (KR); Min Kyu KIM, Seoul (KR); Do Young PARK, Seoul (KR); Reddy Yarram Naresh, Seoul (KR)

(21) Appl. No.: 17/202,547

(22) Filed: Mar. 16, 2021

(30) Foreign Application Priority Data
Jun. 8, 2020 (KR) 10-2020-0069148

(51) Int. Cl. G06N 3/08; G06K 9/62

(52) U.S. Cl. CPC G06N 3/08; G06K 9/6215; G06K 9/6268; G06K 9/6256; G06K 9/6232

(57) ABSTRACT

A method for training a deep learning model according to a disclosed embodiment is performed by a computing device comprising one or more processors and a memory in which one or more programs to be executed by the one or more processors are stored, and the method includes acquiring first training data and extracting training feature vectors from the first training data, classifying the first training data into a plurality of groups based on the extracted training feature vectors, extracting ground-truth feature vectors from ground truths labeled on the first training data, classifying the ground-truth feature vectors into a plurality of groups corresponding to groups of the training feature vectors, calculating group reference information for each group of the ground-truth feature vectors, and setting a quality weight for second training data using the group reference information for each group.

### CROSS-REFERENCE TO RELATED APPLICATION(S) AND CLAIM OF PRIORITY

This application claims the benefit under 35 USC § 119(a) of Korean Patent Application No. 10-2020-0069148, filed on Jun. 8, 2020, in the Korean Intellectual Property Office, the entire disclosure of which is incorporated herein by reference for all purposes.

### BACKGROUND

### 1. Field

The following description relates to a deep learning model training technique.

### 2. Description of Related Art

In recent years, as the processing speed of complex operations has been improved along with the fast development of computer hardware, artificial intelligence (AI)-based deep learning technology has been utilized in various industrial fields. Deep learning technology improves performance through iterative calculations that reduce a difference between an estimated value and a ground truth by learning training data.

In order to improve the performance of deep learning models, an accurate training dataset is required, and thus refinement of training data becomes important. However, as automatic operations utilizing computers take place in various industrial fields, data that are difficult to check with the human eye are generated and numerous data are generated, which leads to a situation beyond the ability of a person to manually refine data.

In other words, ground truths labeled on training data are used in deep learning technology under the assumption that the ground truths are reliable data, but as the amount of data collected in various fields of industries increases, the reliability of the training data cannot be guaranteed, resulting in degradation of the performance of the deep learning model.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

An embodiment of the present invention is intended to provide a method of training a deep learning model which can improve the reliability and performance of a deep learning model, and an apparatus for performing the method.

A method of training a deep learning model according to a disclosed embodiment, which is performed by a computing device comprising one or more processors and a memory in which one or more programs to be executed by the one or more processors are stored, includes: acquiring first training data and extracting training feature vectors from the first training data; classifying the first training data into a plurality of groups based on the extracted training feature vectors; extracting ground-truth feature vectors from ground truths labeled on the first training data; classifying the ground-truth feature vectors into a plurality of groups corresponding to groups of the training feature vectors; calculating group reference information for each group of the ground-truth feature vectors; and setting a quality weight for second training data using the group reference information for each group.

The group reference information may include one or more of a reference feature vector and a standard deviation for each group.

The reference feature vector may be an average vector of ground-truth feature vectors belonging to each group.

The setting of the quality weight may include measuring similarity between a feature vector of a ground truth labeled on the second training data and a reference feature vector of a preset group and setting the quality weight for the ground truth labeled on the second training data based on the measured similarity.

The setting of the quality weight may include calculating relative similarity between the feature vector of the ground truth labeled on the second training data and the reference feature vector based on the measured similarity and setting the quality weight of each ground truth by normalizing the relative similarity calculated for the feature vector of each ground truth labeled on the second training data.

The relative similarity may be calculated by an equation below:

$${w}_{i} = {e}^{\frac{- ( dissimilarity \times dissimilarity )}{2 {σ}^{2}}}$$

wᵢ: relative similarity between a feature vector of a corresponding ground truth and a reference feature vector of a corresponding group

dissimilarity: 1-similarity or a distance between a feature vector of a corresponding ground truth and a reference feature vector of a corresponding group

σ: a standard deviation of a corresponding group

The quality weight of each ground truth may be calculated by an equation below:

$${W}_{i} = \frac{{w}_{i}}{{\sum }_{i = 1}^{N} {w}_{i}}$$

Wᵢ: a quality weight of an i-th ground truth

wᵢ: relative similarity between the i-th ground truth and a reference feature vector of a corresponding group

N: the number of ground truths

The method may further include, subsequent to the setting of the quality weight, updating a loss function of a corresponding deep learning model by applying the quality weight for the second training data to the loss function.

The loss function is updated through an equation below:

$$LossFunction = {\sum }_{i = 1}^{N} ( {W}_{i} \times {lf}_{i} )$$

Wᵢ: a quality weight of an i-th ground truth

lfᵢ: a loss function of the i-th ground truth

N: the number of input ground truths

A computing device according to a disclosed embodiment includes: one or more processors; a memory; and one or more programs, wherein the one or more programs are stored in the memory and configured to be executed by the one or more processors and the one or more programs comprise commands for: acquiring first training data and extracting training feature vectors from the first training data; classifying the first training data into a plurality of groups based on the extracted training feature vectors; extracting ground-truth feature vectors from ground truths labeled on the first training data; classifying the ground-truth feature vectors into a plurality of groups corresponding to groups of the training feature vectors; calculating group reference information for each group of the ground-truth feature vectors; and setting a quality weight for second training data using the group reference information for each group.

The group reference information may include one or more of a reference feature vector and a standard deviation for each group.

The reference feature vector may be an average vector of ground-truth feature vectors belonging to each group.

The command for setting the quality weight may include commands for measuring similarity between a feature vector of a ground truth labeled on the second training data and a reference feature vector of a preset group and setting the quality weight for the ground truth labeled on the second training data based on the measured similarity.

The command for setting the quality weight may include commands for calculating relative similarity between the feature vector of the ground truth labeled on the second training data and the reference feature vector based on the measured similarity and setting the quality weight of each ground truth by normalizing the relative similarity calculated for the feature vector of each ground truth labeled on the second training data.

The relative similarity may be calculated by an equation below:

$${w}_{i} = {e}^{\frac{- ( dissimilarity \times dissimilarity )}{2 {σ}^{2}}}$$

wᵢ: relative similarity between a feature vector of a corresponding ground truth and a reference feature vector of a corresponding group

dissimilarity: 1-similarity or a distance between a feature vector of a corresponding ground truth and a reference feature vector of a corresponding group

σ: a standard deviation of a corresponding group

The quality weight of each ground truth may be calculated by an equation below:

$${W}_{i} = \frac{{w}_{i}}{{\sum }_{i = 1}^{N} {w}_{i}}$$

Wᵢ: a quality weight of the i-th ground truth

wᵢ: relative similarity between the i-th ground truth and a reference feature vector of a corresponding group

N: the number of ground truths

The one or more programs may further include a command for updating a loss function of a corresponding deep learning model by applying the quality weight for the second training data to the loss function.

The loss function may be updated through an equation below:

$$LossFunction = {\sum }_{i = 1}^{N} ( {W}_{i} \times l {f}_{i} )$$

Wᵢ: a quality weight of an i-th ground truth

lfᵢ: a loss function of the i-th ground truth

N: the number of input ground truths

A method of training a deep learning model according to another disclosed embodiment, which is performed by a computing device comprising one or more processors and a memory in which one or more programs to be executed by the one or more processors are stored, includes: acquiring ground truths labeled on first training data; extracting each ground-truth feature vector from each of the ground truths; classifying the ground-truth feature vectors into a plurality of groups; calculating group reference information, which comprises one or more of a reference feature vector and a standard deviation, for each group of the ground-truth feature vectors; extracting feature vectors from ground truths labeled on second training data; setting quality weights for the ground truths labeled on the second training data based on feature vectors of the ground truths labeled on the second training data and reference group information of a preset group; and updating a loss function of a corresponding deep learning model by applying the quality weights of the ground truths to the loss function.

A computing device according to another disclosed embodiment includes: one or more processors; a memory; and one or more programs, wherein the one or more programs are stored in the memory and configured to be executed by the one or more processors and the one or more programs comprise commands for: acquiring ground truths labeled on first training data; extracting each ground-truth feature vector from each of the ground truths; classifying the ground-truth feature vectors into a plurality of groups; calculating group reference information, which comprises one or more of a reference feature vector and a standard deviation, for each group of the ground-truth feature vectors; extracting feature vectors from ground truths labeled on second training data; setting quality weights for the ground truths labeled on the second training data based on feature vectors of the ground truths labeled on the second training data and reference group information of a preset group; and updating a loss function of a corresponding deep learning model by applying the quality weights of the ground truths to the loss function.

Other features and aspects will be apparent from the following detailed description, the drawings, and the claims.

### BRIEF DESCRIPTION OF THE DRAWINGS

FIG. 1 is a block diagram illustrating a configuration of an apparatus for training a deep learning model according to an embodiment of the present disclosure.

FIG. 2 is a diagram schematically showing a reference feature vector and a standard deviation for each group in an embodiment of the present disclosure.

FIG. 3 is a diagram showing a state in which a feature vector is extracted for each ground truth in an apparatus for training a deep learning model according to an embodiment of the present disclosure.

FIG. 4 is a diagram for explaining a state in which a quality weight for each ground truth is calculated in an apparatus for training a deep learning model according to an embodiment of the present disclosure.

FIG. 5 is a flowchart illustrating a method of training a deep learning model according to an embodiment of the present disclosure.

FIG. 6 is a block diagram illustrating an example of a computing environment including a computing device suitable for use in example embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made based on the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

In a description described hereinafter, the terminology of “communication”, “transmission”, “reception”, etc. and terminology similar thereto may include a meaning in which a signal or information is directly transmitted from one element to another element and is transmitted from one element to another element through an intervening element. Particularly, a meaning in which a signal or information is “transmitted” to another element may indicate a final destination of the signal or information and may not mean a direct destination. This may be equally applied with respect to a meaning of “reception” of the signal or information. Further, in this specification, a meaning in which two or more pieces of data or information are related, it may mean that at least a portion of another data (or information) may be obtained based on one data when one data (or information) is obtained.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the teaching of the inventive concept.

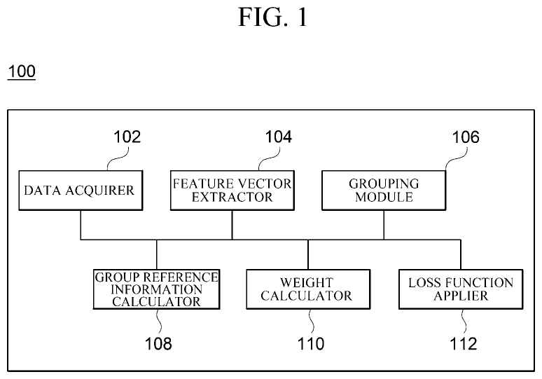

FIG. 1 is a block diagram illustrating a configuration of an apparatus for training a deep learning model according to an embodiment of the present disclosure.

Referring to FIG. 1, an apparatus 100 for training a deep learning model may include a data acquirer 102, a feature vector extractor 104, a grouping module 106, a group reference information calculator 108, a weight calculator 110, and a loss function applier 112.

In an exemplary embodiment, the apparatus 100 for training a deep learning model may be applied to various deep learning models, such as a deep belief network, an auto encoder, a convolutional neural network, a recurrent neural network, and so on.

In addition, in one embodiment, the data acquirer 102, the feature vector extractor 104, the grouping module 106, the group reference information calculator 108, the weight calculator 110, and the loss function applier 112 may be implemented using one or more physically separated devices, or may be implemented by one or more processors or a combination of one or more processors and software, and specific operations thereof may not be clearly distinguished, unlike the illustrated example.

The data acquirer 102 may acquire training data used in the apparatus 100 for training a deep learning model. Also, the data acquirer 102 may acquire a ground truth labeled on each training data.

The feature vector extractor 104 may extract a feature vector from each input training data. In an exemplary embodiment, the feature vector extractor 104 may extract a feature value of a pixel corresponding to a filter having a preset size while moving the filter by predetermined intervals within the training data. The feature vector extractor 104 may extract a feature vector of a one-dimensional matrix by converting the extracted feature value into one dimension. For example, the feature vector extractor 104 may extract a feature vector from each training data through a convolutional neural network, but the feature vector extraction method is not limited thereto. Hereinafter, a feature vector extracted from the training data may be referred to as a “training feature vector”.

In addition, the feature vector extractor 104 may extract feature vectors from ground truths labeled on the training data. In an exemplary embodiment, the feature vector extractor 104 may extract feature vectors from the ground truths through the same convolutional neural network through which the feature vector is extracted from the training data. Hereinafter, the feature vector extracted from the ground truth may be referred to as a “ground-truth feature vector”.

The grouping module 106 may group feature vectors (training feature vectors) extracted from the training data. That is, the grouping module 106 may group the training feature vectors by applying a clustering technique, such as a Gaussian mixture model (GMM) or K-means, to the feature vectors extracted from the training data. The grouping module 106 may assign a group index to each learning feature vector according to the grouping result.

Also, the grouping module 106 may group the feature vectors (ground-truth feature vectors) extracted from the ground truths. The grouping module 106 may determine a group of each ground-truth feature vector based on the group index of the training feature vector corresponding to (i.e., paired with) the ground-truth feature vector.

That is, when the ground-truth feature vectors are grouped only with the ground-truth feature vectors, the grouping may be incorrectly specified by ground-truth training data that is incorrectly mapped with the training data. Thus, the training feature vectors may be grouped and a group may be determined for each ground-truth feature vector paired with each training feature vector according to the group index assigned to the training feature vector.

The group reference information calculator 108 may calculate group reference information for each group of ground-truth feature vectors. Here, the group reference information may include one or more of a reference feature vector and a standard deviation of each group.

The group reference information calculator 108 may calculate a reference feature vector for each group of the ground-truth feature vectors. As shown in Equation 1 below, the group reference information calculator 108 may use the average value of the ground-truth feature vectors belonging to the corresponding group as the reference feature vector of the corresponding group.

$$Reference feature vector = \frac{( {f}_{1} + {f}_{2} + {f}_{3} + ⋯ + {f}_{N} )}{N} \qquad [ Equation 1 ]$$

Here, f denotes a ground-truth feature vector belonging to a corresponding group, and N denotes the number of ground-truth feature vectors belonging to a corresponding group.

In addition, the group reference information calculator 108 may calculate a standard deviation for each group of the ground-truth value feature vectors. The group reference information calculator 108 may calculate a standard deviation for each group through Equation 2 below.

$$σ = \sqrt{\frac{{\sum }_{i = 1}^{N} {( {f}_{i} - μ )}^{2}}{N}} \qquad [ Equation 2 ]$$

Here, σ denotes a standard deviation of a corresponding group, and μ denotes a reference feature vector of the corresponding group.

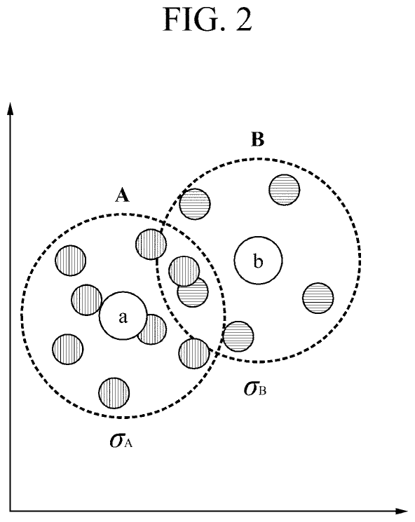

FIG. 2 is a diagram schematically showing a reference feature vector and a standard deviation for each group in an embodiment of the present disclosure. Referring to FIG. 2, reference feature vector a and reference feature vector b are set in group A and group B, respectively. In addition, a range of each of the groups A and B is set through a standard deviation.

The weight calculator 110 may calculate a quality weight based on group reference information for each input training data. Here, the input training data, which is training data that is newly input after the grouping is completed for the ground-truth feature vectors, is data to be trained on by calculating a quality weight based on preset group reference information and applying the calculated quality weight.

That is, group reference information may be calculated from data of the first training unit (hereinafter referred to as “first training data”) and quality weights may be calculated for data of the subsequently input training unit (hereinafter referred to as “second training data”) based on the group reference information. The first training data and the second training data may each be data labeled with a ground truth. Here, the first training data may be the same as or different from the second training data.

The weight calculator 110 may measure similarity between a feature vector extracted from the ground truth labeled on the second training data and a reference feature vector of a preset group. In this case, the feature vector extractor 104 may extract the feature vector from the ground truth labeled on the second training data and transmit the feature vector to the weight calculator 110. In an exemplary embodiment, the weight calculator 110 may measure similarity between the feature vector extracted from the ground truth and the reference feature vector of the preset group through cosine similarity, Euclidean distance, or the like.

In addition, the weight calculator 110 may calculate relative similarity between a feature vector of the corresponding ground truth and the reference feature vector based on the measured similarity. The weight calculator 110 may calculate the relative similarity between the feature vector of the corresponding ground truth and the reference feature vector through Equation 3 below. A value of relative similarity ranges from 0 to 1.

$${w}_{i} = {e}^{\frac{- ( dissimilarity \times dissimilarity )}{2 {σ}^{2}}} \qquad [ Equation 3 ]$$

Here, wᵢ denotes relative similarity between a feature vector of a corresponding ground truth and a reference feature vector of a corresponding group, and σ denotes a standard deviation of the corresponding group. In addition, dissimilarity is 1-similarity or a distance between a feature vector of a corresponding ground truth and a reference feature vector of a corresponding group. Specifically, when cosine similarity is used for measuring the similarity, the similarity may be 1-similarity. In addition, when the Euclidean distance or the like is used for measuring the similarity, the distance between the feature vector extracted from the ground truth and the reference feature vector of the corresponding group may be used intact as the dissimilarity.

The weight calculator 110 may calculate relative similarity for the second training data and each labeled ground truth, and normalize each of the calculated relative similarities to set a quality weight of a corresponding ground truth. The weight calculator 110 may set a quality weight of each ground truth through Equation 4 below.

$${W}_{i} = \frac{{w}_{i}}{{\sum }_{i = 1}^{N} {w}_{i}} \qquad [ Equation 4 ]$$

Here, Wᵢ denotes a quality weight of the i-th ground truth, denotes relative similarity of the i-th ground truth to a reference feature vector of a corresponding group, and N denotes the number of ground truths.

The loss function applier 112 may update a loss function of a corresponding deep learning model based on the quality weight of each ground truth. The loss function applier 112 may update a loss function of a corresponding deep learning model through Equation 5 below.

$$LossFunction = {\sum }_{i = 1}^{N} ( {W}_{i} \times l {f}_{i} ) \qquad [ Equation 5 ]$$

Here, Wᵢ denotes a quality weight of the i-th ground truth, and f denotes a loss function of the i-th ground truth.

According to a disclosed embodiment, by calculating a quality weight for each ground truth and updating a loss function by applying the quality weight thereto, it is possible to shorten the training time required to achieve an optimal goal of a deep learning model and improve the performance of the deep learning model. That is, the quality weight for each ground truth is calculated, so that automatic refinement for a dataset used in the deep learning model can be performed during training, thereby improving the reliability of the deep learning model.

The term “module” as used herein may refer to a functional and structural combination between hardware to implement the technical concept of the embodiments and software to drive the hardware. For example, the term “module” may refer to a logical unit of a predetermined code and hardware resource to implement the predetermined code, and those with ordinary skill in the art may easily understand that the term “module” may not always refer to physically connected codes or only one kind of hardware.

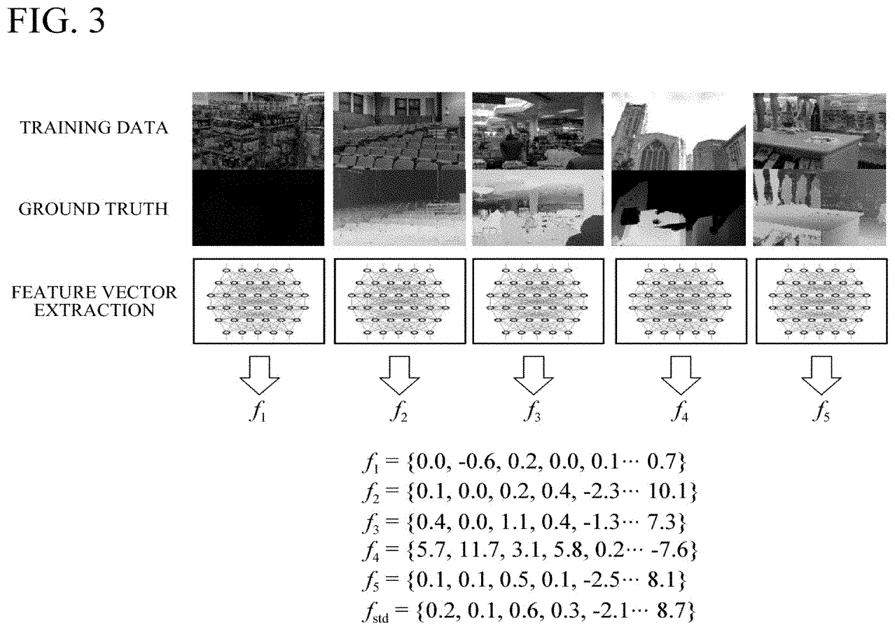

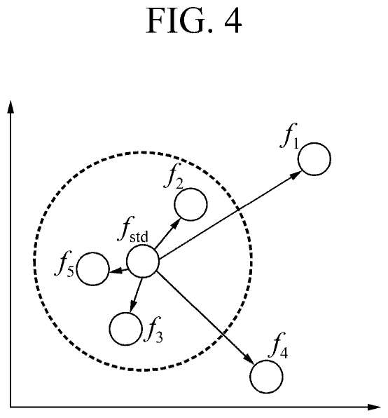

FIG. 3 is a diagram showing a state in which a feature vector is extracted for each ground truth in an apparatus for training a deep learning model according to an embodiment of the present disclosure, and FIG. 4 is a diagram for explaining a state in which a quality weight for each ground truth is calculated in an apparatus for training a deep learning model according to an embodiment of the present disclosure.

Referring to FIG. 3, it is illustrated that five images Img1, Img2, Img3, Img4, and Img5 are input as second training data of a deep learning training model. Here, a case where a ground truth labeled on the second training data is a depth image of each image Img1, Img2, Img3, Img4, and Img5 is illustrated. In this way, when the second training data is input, the feature vector extractor 104 may extract feature vectors f1, f2, f3, f4, and f5 from the ground truths labeled on each of the second training data.

Referring to FIG. 4, the weight calculator 110 may set a quality weight of each ground truth based on the similarity between each feature vector f1, f2, f3, f4, and f5 of each ground truth and a reference feature vector f_{std} of a preset group.

Here, the quality weight W_{Img1} of a first ground truth, the quality weight W_{Img2} of a second ground truth, the quality weight W_{Img3} of a third ground truth, the quality weight W_{Img4} of a fourth ground truth, and the quality weight W_{Img5} of a fifth ground truth may be assumed as follows, respectively.

$${W}_{i m g 1} = \frac{{w}_{1}}{{\sum }_{i = 1}^{5} {w}_{imgi}} \approx 0.01 \\ {W}_{i m g 2} = \frac{{w}_{2}}{{\sum }_{i = 1}^{5} {w}_{imgi}} \approx 0.27 \\ {W}_{i m g 3} = \frac{{w}_{3}}{{\sum }_{i = 1}^{5} {w}_{imgi}} \approx 0.31 \\ {W}_{i m g 4} = \frac{{w}_{4}}{{\sum }_{i = 1}^{5} {w}_{imgi}} \approx 0.08 \\ {W}_{i m g 5} = \frac{{w}_{5}}{{\sum }_{i = 1}^{5} {w}_{imgi}} \approx 0.33$$

Then, the loss function applier 112 may update a loss function of a corresponding deep learning model through Equation 6 below.

Loss Function=0.01×lf_{Img1}+0.27×lf_{Img2}+0.31×lf_{Img3}+0.08×lf_{Img4}+0.33×lf_{Img5} [Equation 6]

In this way, the loss function may be updated by applying a different quality weight for each ground truth, so that the ground truth with low reliability in the loss function is reflected to a lesser extent and the ground truth with high reliability is reflected to a greater extent, thereby improving the reliability and performance of the deep learning model.

That is, in the existing deep learning model, the same weight is applied for each ground truth, but in the disclosed embodiment, a different quality weight is applied for each ground truth, so that the reliability of the deep learning model is increased and the training performance of the deep learning model can be improved.

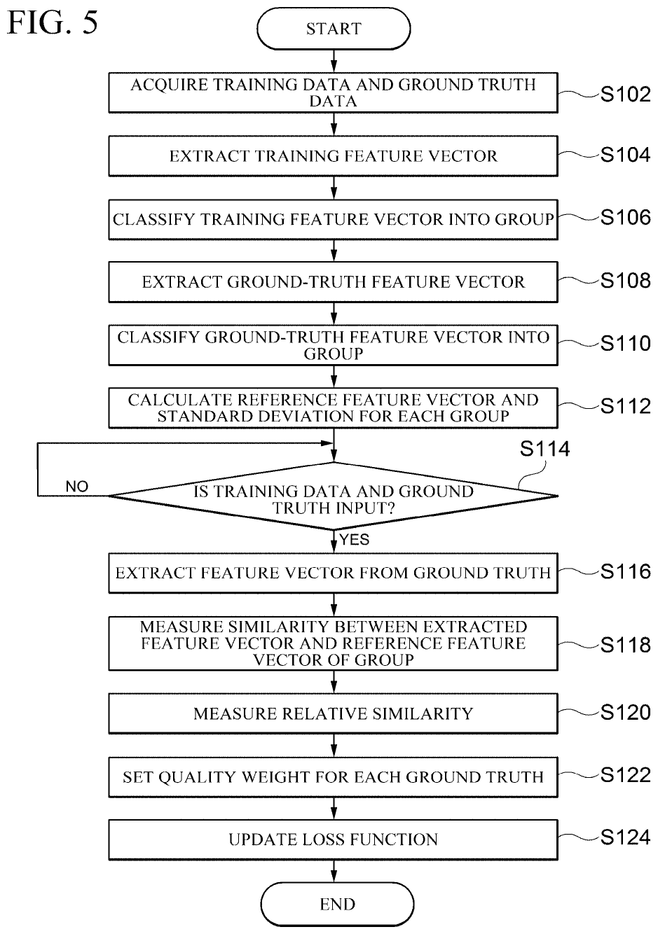

FIG. 5 is a flowchart illustrating a method of training a deep learning model according to an embodiment of the present disclosure. In the illustrated flowchart, at least some of the operations may be performed in different order or may be combined into fewer operations or further divided into more operations. In addition, some of the operations may be omitted, or one or more extra operations, which are not illustrated, may be added to the flowchart and be performed.

Referring to FIG. 5, the apparatus 100 for training a deep learning model acquires training data and a ground truth labeled on the training data (S102). That is, the apparatus 100 for training a deep learning model acquires first training data. These data may be acquired through various known techniques.

Then, the apparatus 100 for training a deep learning model extracts a feature vector (training feature vector) from each training data (S104), and groups the extracted training feature vectors (S106). The apparatus 100 for training a deep learning model may assign a group index to each learning feature vector according to the grouping result.

Then, the apparatus 100 for training a deep learning model extracts a feature vector (ground-truth feature vector) from each ground truth (S108), and classify each ground-truth feature vector into a group based on the group index of the training feature vector paired with the corresponding ground truth (S110).

Then, the apparatus 100 for training a deep learning model calculates group reference information including at least one of a reference feature vector or a standard deviation for each group of the ground-truth feature vectors (S112).

Then, the apparatus 100 for training a deep learning model checks whether training data for training a deep learning model and a ground truth labeled on the training data are input (S114). That is, the apparatus 100 checks whether second training data is input.

As a result of checking in operation S114, when the training data and the ground truth are input, the apparatus 100 for training a deep learning model extracts a feature vector from the input ground truth (S116).

Then, the apparatus 100 for training a deep learning model measures similarity between the feature vector extracted from the ground truth and a reference feature vector of a preset group (S118). Here, the preset group may be a group to which a feature vector extracted from the input ground truth belongs when grouped.

Then, the apparatus 100 for training a deep learning model calculates relative similarity between a feature vector extracted from a corresponding ground truth and the reference feature vector based on the measured similarity (S120).

Then, the apparatus 100 for training a deep learning model normalize the relative similarities calculated for each of the input ground truths to set a quality weight of each ground truth (S122).

Then, the apparatus 100 for training a deep learning model updates a loss function of the deep learning model based on the quality weight of each of the input ground truths (S124).

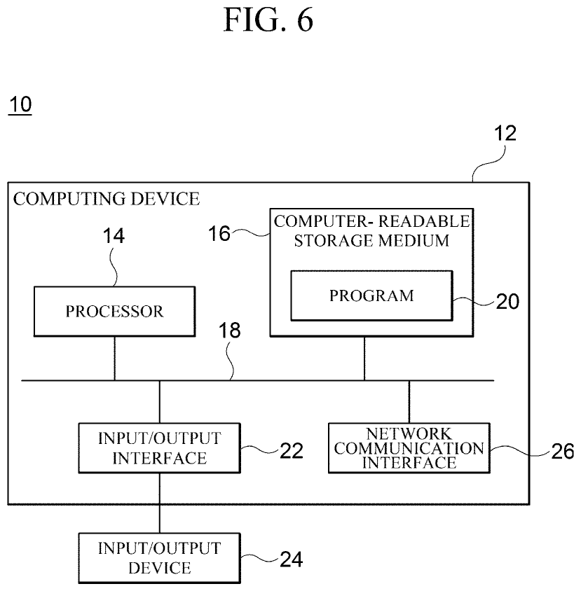

FIG. 6 is a block diagram illustrating an example of a computing environment including a computing device suitable for use in example embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be the apparatus 100 for training a deep learning model.

The computing device 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable instructions, and the computer executable instructions may be configured to, when executed by the processor 14, cause the computing device 12 to perform operations according to the exemplary embodiment.

The computer-readable storage medium 16 is configured to store computer executable instructions and program codes, program data and/or information in other suitable forms. The programs stored in the computer-readable storage medium 16 may include a set of instructions executable by the processor 14. In one embodiment, the computer-readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the disclosed embodiment, by calculating a quality weight for each ground truth and updating a loss function by applying the quality weight thereto, it is possible to shorten the training time required to achieve an optimal goal of a deep learning model and improve the performance of the deep learning model. That is, the quality weight for each ground truth is calculated, so that automatic refinement for a dataset used in the deep learning model can be performed during training, thereby improving the reliability of the deep learning model.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for training a deep learning model which is performed by a computing device comprising one or more processors and a memory in which one or more programs to be executed by the one or more processors are stored, the method comprising:
acquiring first training data and extracting training feature vectors from the first training data;
classifying the first training data into a plurality of groups based on the extracted training feature vectors;
extracting ground-truth feature vectors from ground truths labeled on the first training data;
classifying the ground-truth feature vectors into a plurality of groups corresponding to groups of the training feature vectors;
calculating group reference information for each group of the ground-truth feature vectors; and
setting a quality weight for second training data using the group reference information for each group.

2. The method of claim 1, wherein the group reference information comprises one or more of a reference feature vector and a standard deviation for each group.

3. The method of claim 2, wherein the reference feature vector is an average vector of ground-truth feature vectors belonging to each group.

4. The method of claim 2, wherein the setting of the quality weight comprises:
measuring similarity between a feature vector of a ground truth labeled on the second training data and a reference feature vector of a preset group; and
setting the quality weight for the ground truth labeled on the second training data based on the measured similarity.

5. The method of claim 4, wherein the setting of the quality weight comprises:
calculating relative similarity between the feature vector of the ground truth labeled on the second training data and the reference feature vector based on the measured similarity; and
setting the quality weight of each ground truth by normalizing the relative similarity calculated for the feature vector of each ground truth labeled on the second training data.

6. The method of claim 5, wherein the relative similarity is calculated by an equation below:
$${w}_{i} = {e}^{\frac{- ( dissimilarity \times dissimilarity )}{2 {σ}^{2}}}$$
wherein wᵢ is relative similarity between a feature vector of a corresponding ground truth and a reference feature vector of a corresponding group;
the dissimilarity is 1-similarity or a distance between a feature vector of a corresponding ground truth and a reference feature vector of a corresponding group; and
σ is a standard deviation of a corresponding group.

7. The method of claim 5, wherein the quality weight of each ground truth is calculated by an equation below:
$${W}_{i} = \frac{{w}_{i}}{{\sum }_{i = 1}^{N} {w}_{i}}$$
wherein Wᵢ is a quality weight of an i-th ground truth;
wᵢ is relative similarity between the i-th ground truth and a reference feature vector of a corresponding group; and
N is the number of ground truths.

8. The method of claim 1, further comprising, subsequent to the setting of the quality weight, updating a loss function of a corresponding deep learning model by applying the quality weight for the second training data to the loss function.

9. The method of claim 8, wherein the loss function is updated through an equation below:
$$LossFunction = {\sum }_{i = 1}^{N} ( {W}_{i} \times l {f}_{i} )$$
wherein Wᵢ is a quality weight of an i-th ground truth;
lfᵢ is a loss function of the i-th ground truth; and
N is the number of input ground truths

10. A computing device comprising:
one or more processors;
a memory; and
one or more programs,
wherein the one or more programs are stored in the memory and configured to be executed by the one or more processors; and
the one or more programs comprise commands for:
acquiring first training data and extracting training feature vectors from the first training data;
classifying the first training data into a plurality of groups based on the extracted training feature vectors;
extracting ground-truth feature vectors from ground truths labeled on the first training data;
classifying the ground-truth feature vectors into a plurality of groups corresponding to groups of the training feature vectors;
calculating group reference information for each group of the ground-truth feature vectors; and
setting a quality weight for second training data using the group reference information for each group.

11. The computing device of claim 10, wherein the group reference information comprises one or more of a reference feature vector and a standard deviation for each group.

12. The computing device of claim 11, wherein the reference feature vector is an average vector of ground-truth feature vectors belonging to each group.

13. The computing device of claim 11, wherein the command for setting the quality weight comprises commands for measuring similarity between a feature vector of a ground truth labeled on the second training data and a reference feature vector of a preset group and setting the quality weight for the ground truth labeled on the second training data based on the measured similarity.

14. The computing device of claim 13, wherein the command for setting the quality weight comprises commands for calculating relative similarity between the feature vector of the ground truth labeled on the second training data and the reference feature vector based on the measured similarity and setting the quality weight of each ground truth by normalizing the relative similarity calculated for the feature vector of each ground truth labeled on the second training data.

15. The computing device of claim 14, wherein the relative similarity is calculated by an equation below:
$${w}_{i} = {e}^{\frac{- ( dissimilarity \times dissimilarity )}{2 {σ}^{2}}}$$
wherein wᵢ is relative similarity between a feature vector of a corresponding ground truth and a reference feature vector of a corresponding group;
the dissimilarity is 1-similarity or a distance between a feature vector of a corresponding ground truth and a reference feature vector of a corresponding group; and
σ is a standard deviation of a corresponding group.

16. The computing device of claim 14, wherein the quality weight of each ground truth is calculated by an equation below:
$${W}_{i} = \frac{{w}_{i}}{{\sum }_{i = 1}^{N} {w}_{i}}$$
wherein Wᵢ is a quality weight of the i-th ground truth;
wᵢ is relative similarity between the i-th ground truth and a reference feature vector of a corresponding group; and
N is the number of ground truths

17. The computing device of claim 10, wherein the one or more programs further comprise a command for updating a loss function of a corresponding deep learning model by applying the quality weight for the second training data to the loss function.

18. The computing device of claim 17, wherein the loss function is updated through an equation below:
$$LossFunction = {\sum }_{i = 1}^{N} ( {W}_{i} \times l {f}_{i} )$$
wherein Wᵢ, is a quality weight of an i-th ground truth;
lfᵢ is a loss function of the i-th ground truth; and
N is the number of input ground truths

19. A method for training a deep learning model, which is performed by a computing device comprising one or more processors and a memory in which one or more programs to be executed by the one or more processors are stored, the method comprising:
acquiring ground truths labeled on first training data;
extracting each ground-truth feature vector from each of the ground truths;
classifying the ground-truth feature vectors into a plurality of groups;
calculating group reference information, which comprises one or more of a reference feature vector and a standard deviation, for each group of the ground-truth feature vectors;
extracting feature vectors from ground truths labeled on second training data;
setting quality weights for the ground truths labeled on the second training data based on feature vectors of the ground truths labeled on the second training data and reference group information of a preset group; and
updating a loss function of a corresponding deep learning model by applying the quality weights of the ground truths to the loss function.

20. A computing device comprising:
one or more processors;
a memory; and
one or more programs,
wherein the one or more programs are stored in the memory and configured to be executed by the one or more processors; and
the one or more programs comprise commands for:
acquiring ground truths labeled on first training data;
extracting each ground-truth feature vector from each of the ground truths;
classifying the ground-truth feature vectors into a plurality of groups;
calculating group reference information, which comprises one or more of a reference feature vector and a standard deviation, for each group of the ground-truth feature vectors;
extracting feature vectors from ground truths labeled on second training data;
setting quality weights for the ground truths labeled on the second training data based on feature vectors of the ground truths labeled on the second training data and reference group information of a preset group; and
updating a loss function of a corresponding deep learning model by applying the quality weights of the ground truths to the loss function.
